(19) United States
(12) Patent Application Publication
(10) Pub. No.: US 2011/0224852 A1
(43) Pub. Date: Sep. 15, 2011

(54) METHODS AND SYSTEM FOR SELECTIVELY CHARGING A VEHICLE

(75) Inventors: Elizabeth Profitt-Brown, Plymouth, MI (US); Kelly Lee Zechel, Plymouth, MI (US); Joseph Paul Rork, Canton, MI (US); Brian Petersen, Ferndale, MI (US); Edward Andrew Pleet, Livonia, MI (US); Christopher Adam Ochocinski, Canton, MI (US)

(73) Assignee: FORD GLOBAL TECHNOLOGIES, LLC, Dearborn, MI (US)

(21) Appl. No.: 12/985,807

(22) Filed: Jan. 6, 2011

(51) Int. Cl. B60L 11/18; G06F 1/26

(52) U.S. Cl. 701/22; 700/296

(57) ABSTRACT

One or more embodiments may include a method for selectively charging a vehicle. The method may include receiving at one or more computers one or more periods for charging a vehicle. The vehicle charging periods may be stored in memory. Further, pricing rates for charging the vehicle during the one or more vehicle charging periods may be received at the computer(s). Based on the one or more pricing rates and the vehicle charging periods, one or more low cost charging periods may be determined. The one or more low cost charging periods may be automatically adjusted if the one or more pricing rates change. The vehicle may be charged during at least part of the one or more low cost charging periods.

### BACKGROUND

1. Technical Field

Various embodiments relates to selectively charging a vehicle. In some embodiments, utility costs for charging a vehicle may be controlled or managed through selective vehicle charging.

2. Background Art

An electric vehicle owner may have one or more home charging stations in a home. Not surprisingly, because a home charging station consumes energy, owning an electric vehicle has an effect, sometimes expensive, on the home owner's utility bill. In today's cost conscious society, controlling at least utility costs becomes important for many home owners.

Various OEMs offer software applications that run on a remote device, such as a cellphone, for exchanging information between a remote device and an electric vehicle. For example, a mobile application for the CHEVROLET VOLT permits a user to, among other things, lock and unlock a vehicle, obtain information about the electric vehicle (such as charge status), and receive notifications about the vehicle.

### SUMMARY

At least one aspect may include a computer-implemented method for selectively charging a vehicle. The method may include receiving at one or more computers one or more periods for charging a vehicle which may be stored in memory. Further, the method may include receiving one or more pricing rates for charging the vehicle during the one or more vehicle charging periods.

Based on the one or more pricing rates and the vehicle charging periods, one or more low cost charging periods may be determined on one or more computers. The one or more low cost charging periods may automatically adjusted if the one or more pricing rates change. The method may further include commanding charging of the vehicle during at least part of the one or more low cost charging periods.

Another aspect may include a system comprising one or more computers that may be configured to receive and store one or more periods for charging a vehicle. The computer(s) may be further configured to receive vehicle charging pricing rates. Based on the pricing rates and the vehicle charging periods, the computer(s) may be further configured to identify low cost charging periods and automatically adjust the low cost charging periods if the pricing rates change. Further, the computer(s) may be configured to command charging during the low cost charging periods.

Another aspect may include a computer-program product embodied in a computer-readable medium for selectively charging a vehicle. The computer-program product may include instructions for receiving one or more periods for charging a vehicle and storing the one or more vehicle charging periods in memory. Further instructions may include receiving one or more pricing rates for charging the vehicle during the one or more vehicle charging periods.

Based on the one or more pricing rates and the vehicle charging periods, further instructions may include determining one or more low cost charging periods. Additional instructions may include automatically adjusting the one or more low cost charging periods if the one or more pricing rates change. Further instructions may include commanding charging during at least part of the one or more low cost charging periods.

These and other aspects will be better understood in view of the attached drawings and following detailed description of the invention.

### BRIEF DESCRIPTION OF THE DRAWINGS

The figures identified below are illustrative of some embodiments of the invention. The figures are not intended to be limiting of the invention recited in the appended claims. The embodiments, both as to their organization and manner of operation, together with further object and advantages thereof, may best be understood with reference to the following description, taken in connection with the accompanying drawings, in which:

FIG. 1 illustrates a block topology of a system for remote communication and information exchange with a vehicle;

FIG. 2 illustrates a block topology of a vehicle computing system;

FIG. 3 illustrates an operation for configuring a selective charge time for a vehicle;

FIG. 4 illustrates a process for determining when a selective vehicle charge is performed;

FIG. 5 illustrates a process for determining when a selective vehicle charge is performed based on a vehicle driver's driving habits; and

FIG. 6 illustrates a process for overriding a selective vehicle charge.

### DETAILED DESCRIPTION

Detailed embodiments of the invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

Additionally, the disclosure and arrangement of the figures is non-limiting. Accordingly, the disclosure and arrangement of the figures may be modified or re-arranged to best fit a particular implementation of the various embodiments of the invention.

As will be described in one or more embodiments below, one or more devices remote from a vehicle and a data network connection may be used to remotely communicate and exchange information with a vehicle. In some embodiments, the vehicle may be an electric vehicle. While the various embodiments are described with respect to the use of a battery energy source for the vehicle, other energy storage devices and systems (e.g., and without limitation, fuel, flywheels, supercapacitors, and other like rechargeable energy storage systems) may alternatively or additionally be used without departing from the scope of the invention. The remote device(s) may be in a home, office, school, library, or other like remote location. Typically, the remote location may also provide charging capabilities for an electric vehicle. The remote location may or may not be in the same location as the remote device(s). Further, the remote location may additionally be connected to a network, such as the Internet, a local area network (LAN), wide area network (WAN), and the like.

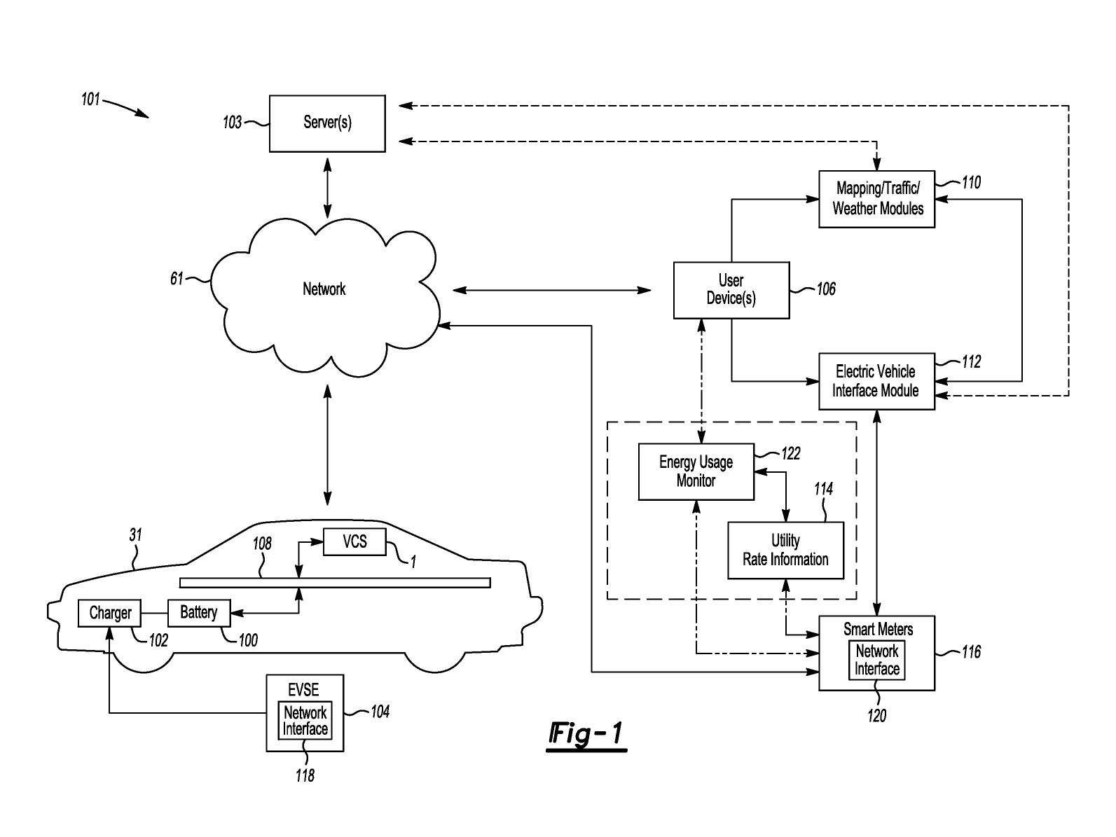

FIG. 1 illustrates a block architecture of a system 101 for remote (e.g., off-board) communication and information exchange with an electric vehicle. However, the arrangement and configuration of FIG. 1 may be modified without departing from the scope of the invention such that the various components may be on board the vehicle or both on board and off board the vehicle.

A plug-in electric vehicle (PEV) 31 may be outfitted with one or more electric battery packs 100 for providing power to the PEV vehicle 31. The battery pack(s) 100 may include one or more chargers 102 for capacitive or inductive charging of the battery pack(s) 100. In some embodiments, the battery pack(s) 100 may not include the charger 102.

Electric vehicle (EV) supply equipment (EVSE) 104 may be used to charge the vehicle 31. Charging may be accomplished using the EV supply equipment 104 by plugging in to the battery pack(s) 100 according to methods known in the art. The EV supply equipment 104 may include a transceiver (e.g., a network interface) 118 for receiving and transmitting data exchanged with the user terminal(s) 106. Further details of this data exchange will be described below.

From one or more user devices 106, which may be at a remote location including, but not limited to, a home, an office, a library, a school, and other like remote locations, a user may exchange information with the vehicle 31. The user device(s) 106 may be one or more personal computers or one or more nomadic devices (including, but not limited to, mobile phones, PDAs, personal media players, and the like).

The user device(s) 106 connection to the network 61 for communication with the vehicle infotainment computer (VCS) 1 may include, but is not limited to, WiFi, WiMax, dial-up, cable modem, DSL, ZigBee and other like wired and wireless connections. Other like network connections may be used without departing from the scope of the invention. Accordingly, the user device(s) 106 may exchange information with the vehicle 31 over a communication network 61 through a wired or wireless connection. A network 61 may be, without limitation, the Internet, a local area network (LAN), a wide area network (WAN), powerline carrier communication (PLC), broadband over power line (BPL) or combinations of such networks. Other like networks may be used without departing from the scope of the invention.

As will be described below, the user device 106 may be configured with one or more software application(s) having graphical interface. In some embodiments, operation of the application(s) may occur using one or more audible commands. In alternative or additional embodiments, the operation may occur with tactile commands.

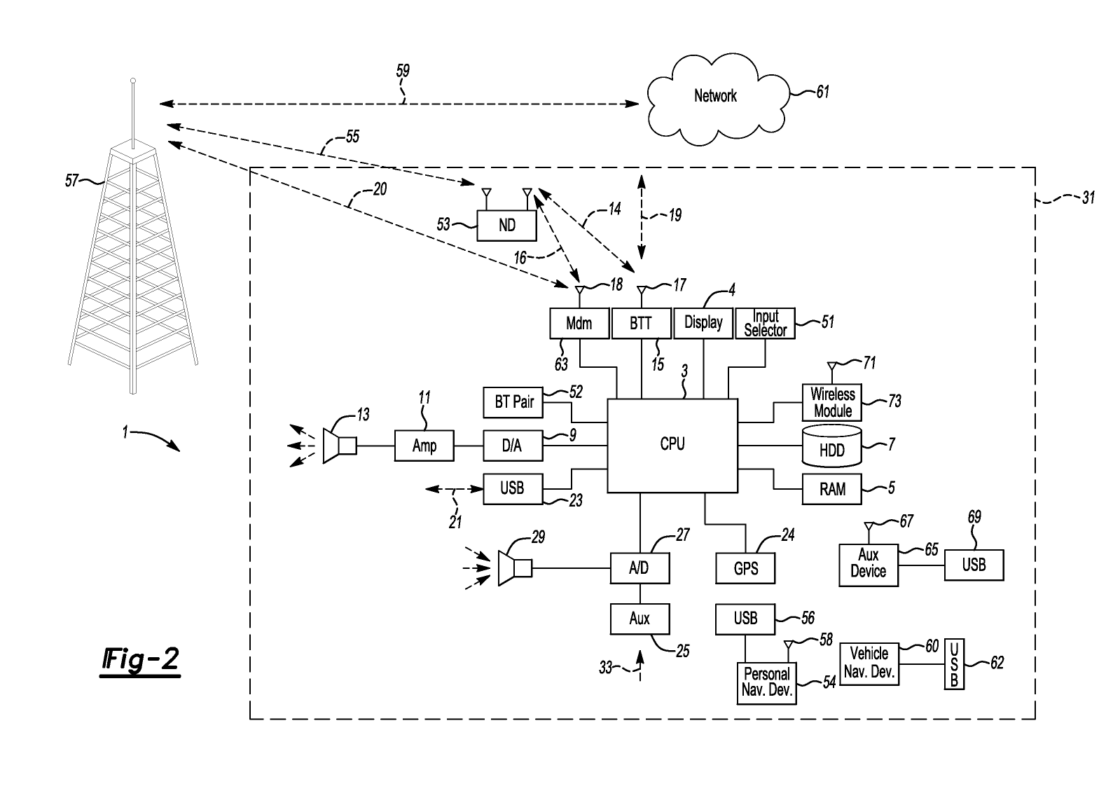

The vehicle 31 may be outfitted with an on-board communication unit for data exchange with the user device 106. The on-board communication unit may include a nomadic device (e.g., without limitation, a cellular phone) which may be used to transmit and receive communications through a cellular network (not shown). These communications may be relayed through network 61. In some embodiments, the on-board communication unit 1 may additionally or alternatively include a modem (not shown) for communication over network 61. As shown in FIG. 1, in some non-limiting embodiments, the on-board communications unit may be a vehicle infotainment computer (VCS) 1. An example of such a VCS 1 is the SYNC system manufactured by THE FORD MOTOR COMPANY. Further details of the VCS 1 will be described below with respect to FIG. 2.

The on-board communications unit (OCU) 1 may be in communication with a vehicle network 108 that communicates data to various vehicle control modules. Non-limiting examples of a vehicle network 108 include an SAE J1850 bus, a CAN bus, a GMLAN bus, and any other vehicle data buses known in the art. As shown in FIG. 1, the one or more battery packs 100 may be connected to the vehicle network 108. Other vehicle modules not shown (e.g., powertrain control modules, airbag control modules, and the like) may also be connected to the network 108. One non-limiting example of information exchanged between the vehicle 31 and the user device(s) 106 may be information about the battery charge. This information may be received by the OCU 1 from the battery 100 via the vehicle network 108.

Referring back to the user device(s) 106, the device 106 may be configured with one or more software modules for information exchange with the EV 31. One non-limiting example of such information exchange may relate to a battery charge. Each of these modules may be implemented on the user device(s) 106 as software. In some embodiments, as represented by the dashed arrows, the modules may be on a remote server 103. Server 103, in some embodiments, may be a third-party server. An application programming interface (API) for interfacing with the modules may or may not be installed on the user device(s) 106. While FIG. 1 illustrates the modules as separate components for illustration, the various embodiments are not limited to this configuration. As a non-limiting example, the modules may comprise a single software application executing on the user device(s) 106 or on a remote server 103. In some embodiments, some modules may be executing locally (e.g., on the user device(s) 106) and others on a remote server 103.

Referring to the specific modules, one or more modules 110 may provide mapping/navigation information, traffic information, and/or weather information. This information may be stored in one or more mapping/traffic/weather databases (not shown) and used by the electric vehicle interface module 112 to exchange trip information with the vehicle 31. In some embodiments, this information may be obtained from a third-party source (e.g., a mapping service, traffic service and/or a weather service) (not shown). This information exchange may occur via data communication including, but not limited to, data-over-voice, the Internet, and the like.

In some embodiments, the module 110 may be also be a trip planning module or may communicate with a trip planning module (not shown). The algorithms implemented on the trip planning module may factor conditions such as (and without limitation) traffic, road conditions (e.g., and without limitation, uphill/downhill, dirt, etc.), road type (e.g., city or highway), and weather in order to provide the trip determination. Other non-limiting factors may include environment friendly travel and lowering carbon cost (e.g., carbon footprint). For example, and without limitation, the determination may include accounting for inclement weather (which may cause the vehicle to use more battery power).

The electric vehicle interface module 112 may be a user-interfacing application for information exchange between the user device(s) 106 and the vehicle 31. As a non-limiting example, the module 112 may receive and monitor a battery charge status. As another non-limiting example, the module 112 may exchange trip information with the vehicle 31.

The module 112 may communicate (via the user device 106) with one or more smart meters 116 from which battery charge information may be obtained. A smart meter 116 may be a device implemented by a utility company that can measure energy consumption by a commercial or residential establishment over a communications network. The smart meters 116 may obtain the charge status from the EV supply equipment 104 by exchanging information with the supply equipment 104. Accordingly, the smart meters 116 may include a network interface 120 for communicating with the EVSE 104. In some embodiments, sub-meters (not shown) may additionally be used for energy usage monitoring.

Battery charge status information may be additionally or alternatively received from the battery 102 via the OCU 1. In this non-limiting embodiment, the OCU 1 may be programmed with logic for translating or converting the battery charge information received via the vehicle network 108 to information capable of being processed and interpreted by the module 112. For example, and without limitation, a look up table stored on the OCU 1 may be used for performing this conversion. Alternatively or additionally, at least part of the conversion/translation may be performed on the user device 106 (e.g., and without limitation, by the module 112).

An energy usage monitoring module 122 may monitor and report the energy usage of one or more appliances within the remote location (e.g., a home or office), including the EVSE 104. The energy usage monitor 122 may obtain usage information from the smart meter 116, the appliances (not shown), or both. These one or more appliances may be connected on a local area network (LAN). In some embodiments, the LAN may be a home area network (HAN). One example of such a module 122 is the MICROSOFT HOHM application from the MICROSOFT CORPORATION.

In some embodiments, the energy usage by some or all appliances at the remote location may be factored into the charge status of the battery. Accordingly, a user may unplug some appliances if a faster charge is desired by the user. In some embodiments, a user may additionally or alternatively defer usage of some devices. The deferment may or may not be automatically programmed from the user device(s) 106. As a non-limiting example, the user may schedule usage of other appliances based on a battery charge time.

System 114 may be a utility data information system operated by and housed at one or more utility companies. The utility data may be determined by a utility company based on information obtained from one or more utility grids owned and operated by the utility company. The utility data may be stored utility data (e.g., and without limitation, in a database) in the system 114 and received by the module 122 from the system 114 via, for example, a communication network (e.g., and without limitation, PLC, BPL, and the like). In some embodiments, the data may be received via the smart meters 116.

FIG. 2 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device).

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data- plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

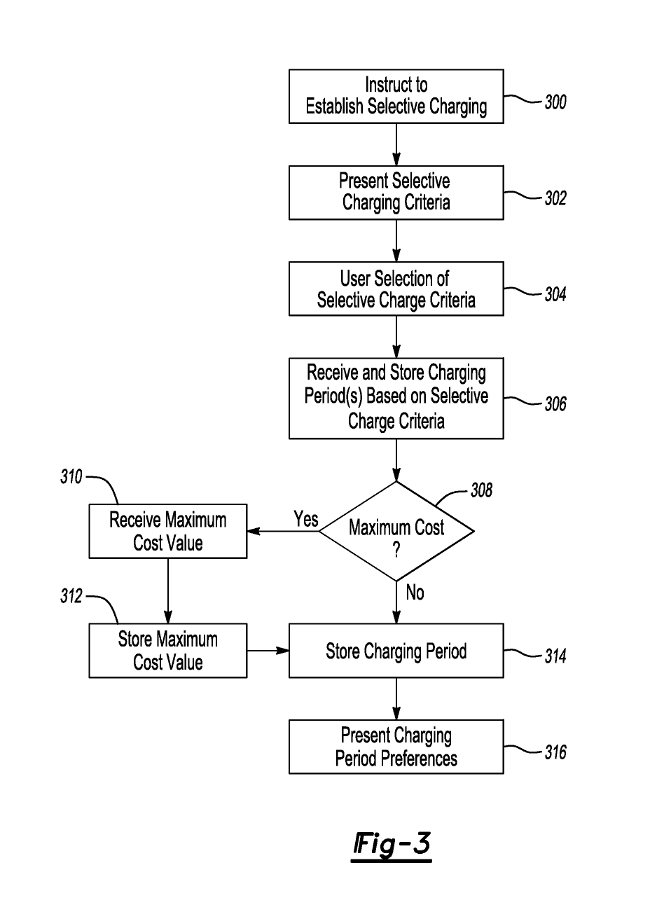

FIG. 3 illustrates a process for establishing a selective charging for a vehicle 31. As one non-limiting example, selective charging may be based on cost of a vehicle charge.

Using tactile and/or verbal commands from the user device(s) 106, instructions to establish selective charging may be input (block 300). The command(s) may be received by the module 112. In some embodiments, the selective charging may be defined and established using an Internet connection. By establishing selective charging, the vehicle may be charged based on selective criteria input by the user. A user may be a utility service user who is charging the vehicle 31. This may include, but is not limited to, a vehicle owner or other driver(s) of the vehicle.

The selective charging criteria may include time, price/cost, or combinations of such criteria. The time may be provided as specific times and/or time ranges (e.g., 12 AM to 6 AM). Further, the price/cost may be provided as specific values, price/cost ranges, and/or representations of price/cost (e.g., “$” to represent a low cost and “$$$$$” to represent a high cost). It will be appreciated that the currency used is for illustration purposes and not intended to be limiting.

The selective charging criteria may be presented at the user device(s) 106 (block 302) and entered by the user (block 304). The selective charging criteria identified by the user may comprise a value charge period (also referred to herein as a “value charge window”) based on which the selective charging may occur.

In some embodiments, the user may select a default value charge window. The default may be preprogrammed to the module 112 based on utility trends of when utility rates may be lower. Accordingly, if a default value charge period is opted by the user, the module 112 may charge the vehicle 31 during the default period(s).

The user may input one or more selective charging criteria that define multiple value charging periods. As one non-limiting example, the user may input multiple times. Each time may be associated with a price/cost. Therefore, the multiple value charging windows may be defined by a time and a price/cost for charging.

The one or more value charging periods defined by the user may comprise a value charging profile for the user. In some embodiments, the value charging profiles may be associated with one or more locations where the vehicle 31 is charged. The location(s) may be identified based on GPS location of the charging station. Alternatively or additionally, the location(s) may be input by the user. For example, and without limitation, the user may input an address of the location. As another non-limiting example, one or more POIs may be input as the location. In some embodiments, the location(s) may be additionally associated with a user-defined name (e.g., “home” or “work”). As will be described in further detail below, based on the value charge profile, the system 101 may schedule vehicle charging based on the lowest priced value charging windows in order to provide the user the lowest possible cost for vehicle charging.

The value charging window(s) may comprise off-peak charging periods. Typically, peak charging periods may be at higher cost rates than off-peak charging periods. In the case where a user does not have a variable rate energy plan, the off-peak periods may reduce stress on the energy grid.

The value charge period(s) defined by the user may be received and stored in memory (block 306). Accordingly, the value charge window(s) may be used to determine when to charge the vehicle. The value charge window(s) may be stored in memory of the user device(s) or, in some embodiment, on a centralized system 103 communicating with the vehicle 31 and the user device(s) 106. In some embodiments, the centralized system 103 may be one or more servers.

The centralized server system 103 may further include processing capability for incoming signals from the user device(s) 106 designated to interact with the vehicle 31. For example, the server(s) may include an automated call server and/or web host. Further, the server(s) 103 may route an incoming signal from the user device(s) 106 to the appropriate remote vehicle. Data sent in this fashion may be sent using data-over-voice, a data-plan, or in any other suitable format. Once the server(s) 103 receive the incoming data request from the user device(s) 106, the message may be processed and/or relayed to the vehicle 31. The vehicle 31 may be identified by a header associated with one or more incoming data packets, or may be identifiable based on a database lookup, for example. The relay to the vehicle 31 may be sent out from the server(s) 103 through a network (e.g., without limitation, a cellular network, the internet, etc.) and to the vehicle 31.

In some embodiments, a maximum price/cost for charging may be defined by the user (block 308). In this case, the vehicle may be charged, based on the identified value charge window(s), such that the cost for charging the battery is no more than the maximum price/cost. In some instances, the state of the charge may not be a full charge based on the price/cost associated with the value charge window.

The maximum price/cost may be defined by the user and entered to the module 112 (block 310). Additionally, the maximum value may be stored in memory of the user device(s) 106 or the centralized system (block 312).

The value charging period may be stored in memory which, as represented by block 308, may or may not be stored with the maximum price/cost (block 314). Further, the user may be presented with the value charging period(s) (block 316). The value charging period(s) may be presented in response to user input requesting the value charging period(s). In some embodiments, the value charging period(s) may be modified by the user.

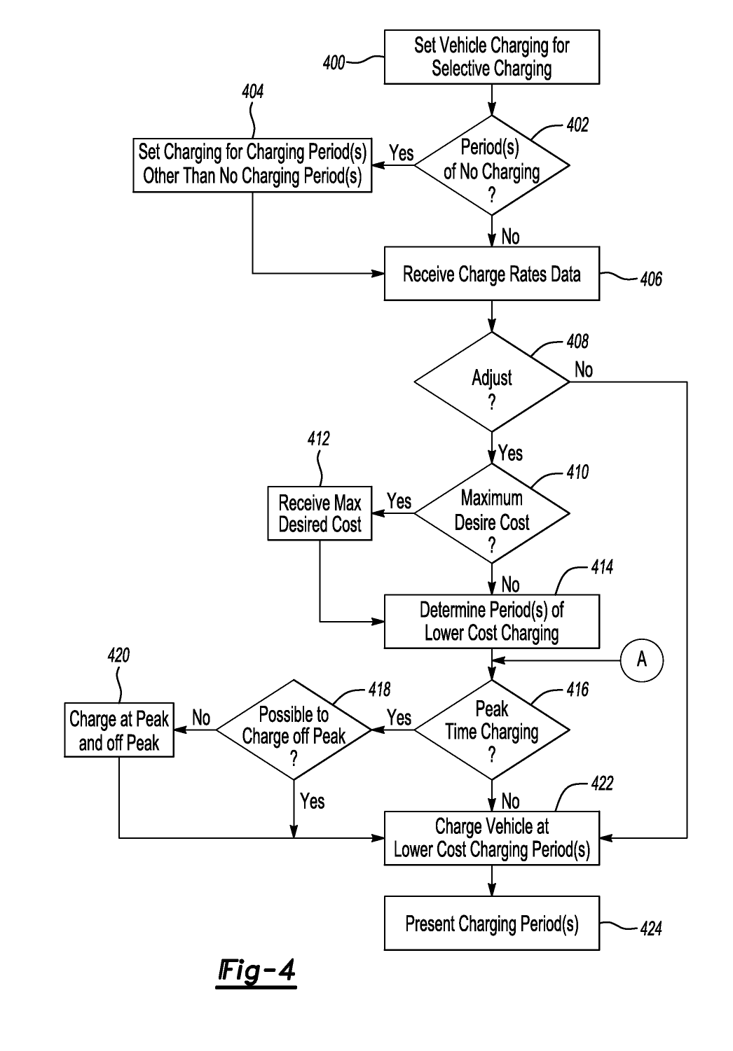

FIG. 4 illustrates a process for selective charging based on the value charging period(s). The selective charging may be enabled at the user device(s) 106 (block 400). In some embodiments, selective charging may be enabled in response to a user action such as, and without limitation, starting the application 112 and/or inputting a tactile and/or verbal enabling command. In some embodiments, once selective charging in enabled, selective charging may not need to be enabled again unless selective charging is disenabled.

A determination may be made if the user has assigned period(s) of no charging (block 402). The period(s) of no charging may be assigned and modified using the module 112. Period(s) of no charging may include, but is not limited to, period(s) when the vehicle is being used, when no charging is available, and/or when no charging is desired. As a non-limiting example, the user may leave daily at 8:00 AM. Accordingly, the user may set 8:00 AM as a predetermined departure times when no charging will occur. Accordingly, charging may be set for period(s) other than the no charging period(s) (block 404). Further, the period(s) that the vehicle 31 is being charged may occur within the value charging period(s). Period(s) of no charging may be assigned as specific times, time ranges or days of the week and/or as general periods such as morning, afternoon, evening, daily, weekly, monthly, and the like.

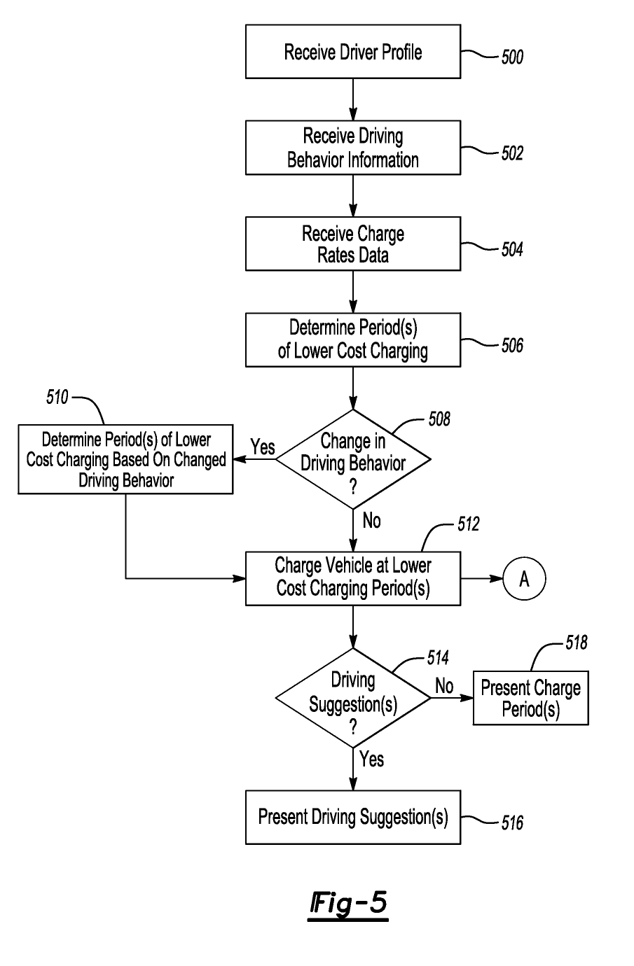

In some embodiments, the period(s) of no charging may be used by the module 112 as defining by when the vehicle 31 should be charged to at least complete roundtrip travel. As will be described in further detail with respect to FIG. 5, the driver's driving habits may be used in vehicle charging decisions by the module 112 (e.g., and without limitation, how much to charge and/or when to charge).

In some embodiments, the period(s) of no charging may be additionally or alternatively used to define when no charging should take place unless completely necessary. For example, the period(s) defined as no charging period(s) may have a high charging price rate (“peak” charging) and, therefore, charging may be restricted during the period(s) unless the restricted charging period(s) is needed to complete charging of the vehicle before vehicle use.

The charging price rate data for charging the vehicle 31 may be received for the value charge period(s) (block 406). The charging price rates may be received from the one or more utility companies 114. In some embodiments, the charging price rate may be received by the energy usage module 122 and requested by the module 112. The price rate data may be received and stored in memory. In some embodiments, as illustrated by the broken lines in FIG. 1, the price rate data may be stored at a third-party computing system (e.g., where the module 122 is executing). Further, the charging price rate data may be received periodically. For example, and without limitation, the data may be received daily, weekly, or variations thereof. In some embodiments, the rate data may be received with each vehicle charge.

At certain times, the pricing rate data provided by the utility companies may change. Typically, when the utility rate changes, the utility customer may not know of the change until the utility bill arrives or may call the utility provider to inquire about a pricing change. In such scenarios, if, for example, the pricing change is an increase, the utility customer may manually adjust utility usage to reduce utility costs.

As illustrated in FIG. 4, the module 112 may automatically determine, based on the received utility rates, if the pricing rate has changed and, therefore, whether the period(s) of charging based on the value charging window(s) should be adjusted (block 408). This determination may be made based on a comparison of previous charging rates in the value charging window(s) (which, e.g., may be stored in memory) to the received charging rates data (block 406). If there is no adjustment needed, the vehicle may be charged at charging period(s) providing a lower cost for the utility user (block 422).

Otherwise, if the period(s) of charging are adjusted (block 408), the period(s) of lower cost charging may be determined (block 414) based on the pricing rates from the utility information 114. In cases where a maximum cost may be defined by the user (if any) (block 410), the maximum cost may be received (block 412), and the lower cost charging period(s) determined so that the cost is lower than or equal to the maximum cost (block 414) as described above.

As described above, the value charging window(s) may comprise off-peak charging periods. Accordingly, based on the value charge window(s), the vehicle may be charged during off-peak period(s) to ensure a lower charging cost for the user. In some instances, charging may occur at peak periods. For example, if a charge cannot be complete during off-peak charging period(s) before the vehicle is scheduled to be used (e.g., based off the no charge period(s)), the charge may be completed during peak period(s).

Accordingly, in some embodiments, it may be determined if a charging period includes higher rate (e.g., peak time) charging (block 416). If so, it may be determined if lower cost charging (e.g., off-peak) is possible (block 418). For example, and without limitation, delayed off-peak charging may be possible if the current charge is sufficient for the driver to reach the next destination (e.g., which may have a charging station) where the off-peak charging may continue. The destination may be entered by the user from the user device(s) 106 or the in-vehicle navigation system 54, 60. In some embodiments, the driver may be notified to plug in the vehicle at the next destination.

If off-peak charging is not possible, the vehicle may be charged during peak and off-peak charging periods (block 420). Notwithstanding the peak and off-peak charging periods, the vehicle may be charged to obtain the lowest charging cost (block 422).

As stated above, when charging is performed at off-peak periods (e.g., the vehicle is not charged at peak periods) (block 416), the vehicle charging may occur when charging costs are lower (block 422).

In some embodiments, the charging period(s) may be presented at the user device(s) 106 (block 424). The presentation of the charging period(s) may be in response to audible and/or tactile user input.

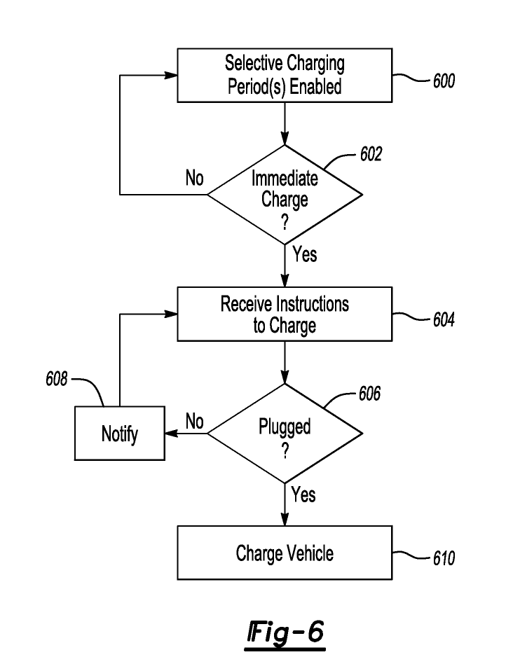

In some embodiments, as described with respect to FIG. 6 below, the user may override the programmed selective charging. Instructions may be input from the user device(s) 106 (e.g., using audible and/or tactile inputs) via the module 112 and the vehicle may be charged immediately, if the vehicle is plugged. If the vehicle is unplugged, a notification may be transmitted to the user device(s) 106 with an alert that the vehicle is unplugged.

In some embodiments, the driver's driving habits may be used as part of the cost effective charging. FIG. 5 illustrates a process for using driver's habits as part of the selective charging process.

A driver profile may be created and stored in memory (e.g., at the server system 103 or the user device(s) 106). The driver profile may be created automatically based on driving behavior. Additionally or alternatively, the driving profile may include information provided by the driver.

The driving profile, which may be associated with each driver based on a vehicle key identifier or a user identifier, may include historical driving habits of the driver. The identifier may be assigned by the system 101 and/or provided by the user. For example, and without limitation, the user may provide the vehicle key identifier or the user identifier during a user registration process.

In some embodiments, the driving behavior information may be stored after every vehicle drive. As a non-limiting example, information about the vehicle drive may be stored at key-off. Using the identifier, the driver's driving behavior may be retrieved. Non-limiting examples of driving behavior may include distance (e.g., on a period basis such as daily, weekly, monthly, etc.), destinations, driving times, driving days, driving style (e.g., hard braking and speed), driving terrain, and other such behaviors. In some embodiments, driving behaviors (e.g., times and days of departure) may be used as an addition or alternate to the no charge period(s). Accordingly, using the driver profile (block 500), the driver's driving behavior may be received by the module 112 (block 502).

The charging rates may be received from the utility information 114 (block 504). Based on the rates, the lower cost charging period(s) may be determined (block 506). If the user has provided value charge window(s), the lower cost charging period(s) may be determined based on the value charge window(s).

In some instances, there may be a change in driving behavior (block 508). As a non-limiting example, the user may drive one or more times to a different destination than another destination stored in the driver profile as being visited during a particular time. In this case, the period(s) of low cost charging may be determined based on the driving behavior change (block 510). In some embodiments, the determination may be made on repetitive changes. In some embodiments, the change(s) may be stored in the driver profile.

The driving profile information may influence the extent of vehicle charging. Consequently, in some embodiments, the extent of vehicle charging may influence the cost of charging. By way of example and not limitation, based on the driving profile information (e.g., and without limitation, excessive hard braking), a longer charge may be needed for a vehicle for a particular distance (as compared to the amount of charge needed when another driver who travels the same distance in the same car). As such, there may be more peak time charging for the driver.

The vehicle may be charged at the lower cost charging periods(s) (block 512). Of course, as represented by circle block A (and illustrated in FIG. 4), the process may also include determining during which period(s) the vehicle may be charged (e.g., peak and/or off-peak).

In some embodiments, driving suggestions may be provided at the user device(s) 106 based on a user request (e.g., through an audible and/or tactile input) (block 514). These suggestions for driving may relate to, for example, suggestions for optimizing use of the battery charge, environmentally friendly driving, and others. If requested, the driving suggestion(s) may be presented at the user device(s) 106 (block 516) along with the charging period(s) (block 518).

FIG. 6 illustrates an override process for the programmed selective charging. Alternatively, FIG. 6 illustrates a process for immediate charging capability.

The selective charging period(s) may be, although not necessarily, enabled (block 600). If enabled, the user may not seek to override charging during the selective charging period(s) (block 602). That is, the user may not elect to activate immediate charging.

If immediate charging is activated, the instructions to immediately charge may be received by the module 112 (block 604). Immediate charging may occur if the vehicle is plugged. If the vehicle is not plugged (based on information received from the vehicle 31), a notification may be received at the module 112 (block 608) that the vehicle is not plugged. The user may reinstruct immediate charging (block 604).

However, if the vehicle is plugged (block 606), the instructions to charge may be transmitted from the user device(s) 106 (e.g., by the module 112) to the vehicle. Accordingly, the vehicle may be charged (block 610).

While exemplary embodiments are illustrated and described above, it is not intended that these embodiments illustrate and describe all possibilities. Rather, the words used in the specification are words of description rather than limitation, and it is understood that various changes may be made without departing from the spirit and scope of the invention.

1. A computer-implemented method for selectively charging a vehicle, the method comprising:
receiving at one or more computers one or more periods for charging a vehicle;
storing the one or more vehicle charging periods in memory;
receiving one or more pricing rates for charging the vehicle during the one or more vehicle charging periods;
based on the one or more pricing rates and the vehicle charging periods, determining on the one or more computers one or more low cost charging periods, wherein if the one or more pricing rates change, the one or more low cost charging periods are automatically adjusted; and
commanding charging of the vehicle during at least part of the one or more low cost charging periods.

2. The computer-implemented method of claim 1 further comprising storing the one or more vehicle charging periods as one or more charging profiles for the vehicle.

3. The computer-implemented method of claim 2 further comprising associating the one or more charging profiles with one or more charging locations.

4. The computer-implemented method of claim 3 further comprising receiving at least one of user input and GPS data defining the one or more charging locations.

5. (canceled)

6. The computer-implemented method of claim 1 further comprising receiving a user-defined maximum price for the low cost charging.

7. The computer-implemented method of claim 6 wherein the vehicle charging occurs during at least part of the one or more low cost charging periods until the cost, based on a charge status of a vehicle energy source, is less than or equal to the user-defined maximum.

8. The computer-implemented method of claim 1 further comprising:
based on the one or more pricing rates and the vehicle charging periods, determining on the one or more computers one or more higher cost charging periods;
determining if at least a part of the vehicle charging must occur during the one or more higher cost charging periods; and
if so, remotely transmitting charging instructions from the one or more computers to the vehicle to enable charging during at least part of the one or more higher cost charging periods.

9. The computer-implemented method of claim 8 further comprising monitoring at the one or more computers for one or more no charge periods during which no charging occurs, wherein at least a part of the vehicle charging occurs during higher cost charging periods to complete charging before the one or more no charge periods.

10. The computer-implemented method of claim 8 further comprising attaining a lower cost charging through a combination of charging during the low cost charging periods and the higher cost charging periods.

11. The computer-implemented method of claim 8 wherein the low cost charging periods occur during off-peak utility pricing periods and the higher cost charging periods occur during peak utility pricing periods.

12. A system comprising:
one or more computers configured to:
receive and store one or more periods for charging a vehicle;
receive vehicle charging pricing rates;
based on the pricing rates and the vehicle charging periods, identify low cost charging periods;
automatically adjust the low cost charging periods if the pricing rates change; and
command charging during the low cost charging periods.

13. The system of claim 12 wherein the one or more computers include at least one of one or more nomadic devices, one or more personal computers, one or more server systems, or one or more vehicle computing systems.

14. The system of claim 12 wherein the one or more computers are further configured to:
receive information identifying one or more vehicle drivers;
receive one or more driving behaviors for the one or more identified vehicle drivers; and
based additionally on the one or more driving behaviors, identify the low cost charging periods.

15. The system of claim 14 wherein the one or more computers are further configured to determine an extent of charging during the low cost charging periods.

16. The system of claim 14 wherein the driving behaviors include at least one of one or more times of departure, one or more days of departure, one or more driving styles, one or more driving distances, and one or more driving terrains.

17. The system of claim 12 wherein the one or more computers are further configured to record analytics relating to vehicle usage.

18. A computer-program product embodied in a computer-readable medium for selectively charging a vehicle and comprising instructions for:
receiving one or more periods for charging a vehicle;
storing the one or more vehicle charging periods in memory;
receiving one or more pricing rates for charging the vehicle during the one or more vehicle charging periods;
based on the one or more pricing rates and the vehicle charging periods, determining one or more low cost charging periods;
automatically adjusting the one or more low cost charging periods if the one or more pricing rates change; and
commanding charging during at least part of the one or more low cost charging periods.

19. The computer-program product of claim 18 further comprising instructions for receiving one or more no charge periods during which no charging occurs, the low cost charging periods comprising periods other than the one or more no cost charge periods.

20. (canceled)

21. The computer-program product of claim 19 wherein the no charge periods include periods when the vehicle is in use.

22. The computer-program product of claim 18 further comprising instructions for overriding the instructions for charging during at least part of the one or more low cost charging periods.
